(19) United States
(12) Patent Application Publication
(10) Pub. No.: US 2020/0286216 A1
(43) Pub. Date: Sep. 10, 2020

(54) DETERMINATION SYSTEM, METHOD AND PROGRAM

(71) Applicant: OPTIM CORPORATION, Saga (JP)

(72) Inventor: Shunji SUGAYA, Tokyo (JP)

(21) Appl. No.: 16/632,205

(22) PCT Filed: Jul. 28, 2017
(86) PCT No.: PCT/JP2017/027349

§ 371 Date: Apr. 30, 2020

(51) Int. Cl. G06T 7/00; G06K 9/00

(52) U.S. Cl. CPC G06T 7/0002; G06T 7/97; G06T 2207/30188; G06K 9/00362; G06T 2207/30196; G06K 9/00657

(57) ABSTRACT

Provided is a decision system (1) which includes: a control unit (11) in a computer device (10) executes an image acquisition module (111) to issue an instruction to a capture unit (20) to enable the capture unit (20) to acquire images of a same object in a plurality of directions; next, the control unit (11) executes a decision module (112) to analyze the images acquired from the directions, and decide, with reference to a decision criterion database (134) stored in a storage unit (13), whether decision criteria are satisfied, where the decision criteria are separately determined for the directions in which the images are acquired; next, the control unit (11) executes a provision module (113) to provide, based on results of decisions, a decision result for the object.

### TECHNICAL FIELD

The present disclosure relates to a decision system, method and program by use of captured images.

### BACKGROUND

In the past, a system has been proposed for notification of a prone state when a human, such as a baby, is lying prone.

For example, a state detection device is provided, which includes a capture unit, a specific state detection unit, and a monitor notification unit. The capture unit is configured to capture a detection object. The specific state detection unit is configured to detect a specific state of the detection object based on a change of the detection object which is sensed from a capture result of the capture unit. The monitor notification unit is configured to notify a monitor that the specific state has been detected (referring to Patent Literature 1). With to this device, the state detection device can be provided simply and cheaply because it is unnecessary to use more sensors than the capture unit. In addition, it is unnecessary to equip the detection object with a sensor or the like, and thus the discomfort and resistance of the detection object can be reduced.

For example, a state detection device is provided, which includes a capture unit, a specific state detection unit, and a monitor notification unit. The capture unit is configured to capture a detection object. The specific state detection unit is configured to detect a specific state of the detection object based on a change of the detection object which is sensed from a capture result of the capture unit. The monitor notification unit is configured to notify a monitor that the specific state has been detected (referring to Patent Literature 1). With this device, the state detection device can be provided simply and cheaply because it is unnecessary to use more sensors than the capture unit. In addition, it is unnecessary to equip the detection object with a sensor or the like, and thus the device can reduce the discomfort and the sense of resistance of the detection object.

### LITERATURE IN THE EXISTING ART

### Patent Literature

Patent Literature 1: Japanese Patent Publication number 2017-018455

### SUMMARY

### Problems to be Solved

However, for the state detection device in Patent Literature 1, the situation where sensors other than a capture unit are not use also exists. In this situation, the condition of a detection object in a specific state cannot be sufficiently detected in some cases. Therefore, it is required provide a system which can detect, with higher accuracy, the condition of the detection object is in the specific state even if sensors other than the capture unit are not used.

Therefore, the present disclosure aims to provide a system which can detect, with the higher accuracy, the condition of the detection object in the specific state even if sensors other than the capture unit are not used.

### Solutions to the Problems

The present disclosure provides solutions described below.

An invention according to a first feature provides a decision system including an image acquisition unit, a decision unit and a provision unit. The image acquisition unit is configured to acquire images of a same object from a plurality of directions. The decision unit is configured to analyze the images acquired from the directions, and decide whether decision criteria are satisfied, where the decision criteria are separately determined for the directions in which the images are acquired. The provision unit is configured to provide, based on results of decisions, a decision result for the object.

With the invention according to the first feature, the images are acquired for the same object from multiple directions, it is separately decided whether the images acquired in the directions separately satisfy the decision criteria, and the decision result is finally provided based on the results of the individual decisions. Previously, in the case where no other sensors are used other than the capture unit, a final decision result is derived using merely an image acquired from one direction. In the invention according to the first feature, so long as an image acquisition device which is easier to purchase than the other sensors is configured to be able to acquire the images of the same object from the plurality of directions, it is possible to derive the decision result with the higher accuracy for a specified decision item even without using the other sensors.

An invention according to a second feature provides the decision system which is the invention according to the first feature, where the provision unit is configured to provide a result obtained by dividing a number of images which are decided to satisfy the decision criteria by a number of the acquired images as a proportion of images which are decided to satisfy the decision criteria.

With the invention according to the second feature, the decision result provided for the object is provided along with the proportion of the images which are decided to satisfy the individual decision criteria. Therefore, the confidence degree of the decision result can be learned. For example, to further increase the confidence degree, the following method may be added as an option: another decision system which has higher accuracy and is more expensive is used for screening.

### Effects of the Present Disclosure

According to the present disclosure, so long as the image acquisition device which is easier to purchase than the other sensors is configured to be able to acquire the images of the same object in the plurality of directions, it is possible to derive the decision result with the higher accuracy for the specified decision item even without using the other sensors.

### BRIEF DESCRIPTION OF DRAWINGS

FIG. 1 is a schematic diagram illustrating hardware composition of a decision system 1 in an embodiment.

FIG. 2 is a block diagram illustrating hardware composition and software functions of a decision system 1 in an embodiment.

FIG. 3 is a flowchart of a decision method in an embodiment.

FIG. 4 is a diagram illustrating an example of a decision criterion database 134.

### DETAILED DESCRIPTION

Embodiments for implementing the present disclosure will be described below with reference to the accompanying drawings. It is to be noted that the embodiments are merely examples and not intended to limit the scope of the present disclosure.

Composition of a Decision System 1

(Hardware Composition)

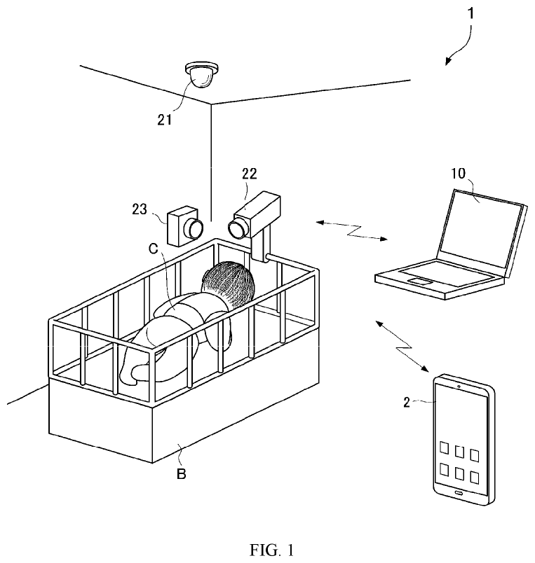

FIG. 1 is a schematic diagram illustrating hardware composition of a decision system 1 in an embodiment.

The present embodiment, as an example, describes that a capture object is a baby on a bed, and the decision system 1 decides whether the baby is prone. However, it is not limited thereto. For example, the capture object may also be a person or an animal, and the decision system 1 may also be a device that decides a specified action of the person or the animal. In addition, the capture object may also be a pregnant woman or a pregnant animal, and the decision system 1 may also be a device that decides a progress of pregnancy. In addition, the capture object may also be a crop, and the decision system 1 may also be a device that decides a breeding state of the crop. In addition, the capture object may also be a cultured fish, and the decision system 1 may also be a device that decides a health state of the cultured fish. The capture object may also be a mechanical device, a mechanical component, a building, or the like, and the decision system 1 may also be a device that decides their fault or damage.

Hereinafter the example in which the capture object is a baby on a bed and the decision system 1 is a system which decides whether the baby is lying prone will be described.

The decision system 1 includes a computer device 10 and a capture unit 20 which is configured to be able to capture the capture object.

The computer device 10 can be any device capable of performing specified arithmetic processing and is not particular limited.

The capture unit 20 is a camera which converts (captures) an optical image taken through a lens into an image signal through a capture element such as a charge-coupled device (CCD) or a complementary metal oxide semiconductor (CMOS). The type of the capture unit 20 may be appropriately selected according to an image analyzing method for the capture object.

The capture unit 20 is configured to acquire images of a same object from multiple directions. In the present embodiment, the capture unit 20 includes a ceiling capture unit 21, a front capture unit 22, and a lateral capture unit 23. The ceiling capture unit 21 is configured to acquire an image of the baby C on the bed B from a ceiling direction. The front capture unit 22 is configured to acquire an image of the baby C from a front direction. The lateral capture unit 23 is configured to acquire an image of the baby C from a lateral direction.

In addition, although it is unnecessary, a portable terminal 2 may also be provided for a guardian of the baby C to check a result of the specified arithmetic processing of the computer device 10 at a remote place.

Relationship Between Hardware Composition and Software Functions

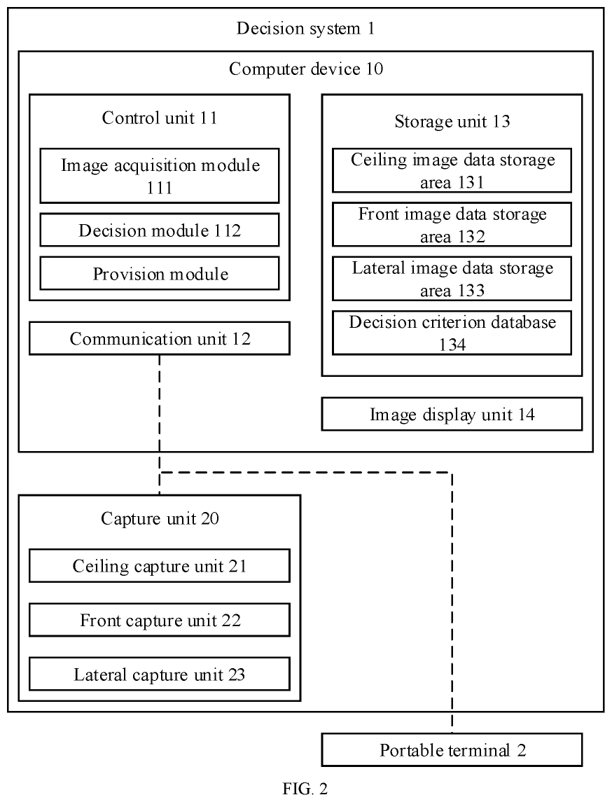

FIG. 2 is a block diagram illustrating hardware composition in collaboration with software functions of the decision system 1. The computer device 10, the capture unit 20, and the portable terminal 2 are connected to each other via a network.

The computer device 10 includes a control unit 11 for controlling data, a communication unit 12 for communicating with other devices, a storage unit 13 for storing data, and an image display unit 14 for displaying the result of the specified arithmetic processing of the control unit 11.

The control unit 11 includes a central processing unit (CPU), a random access memory (RAM), a read only memory (ROM) and the like.

The control unit 11 reads a specified program and cooperates with the communication unit 20 as required, so as to implement an image acquisition module 111, a decision module 112, and a provision module 113.

The communication unit 12 includes elements which can communicate with the other devices.

The storage unit 13 includes a data storage unit which is a device for storing data and files and is implemented by a hard disk, a semiconductor memory, a recording medium, a memory card or the like. The storage unit 13 stores a ceiling image data storage area 131, a front image data storage area 132, a lateral image data storage area 133, and a decision criterion database 134, which are described later.

Flowchart of a Decision Method Using the Decision System 1

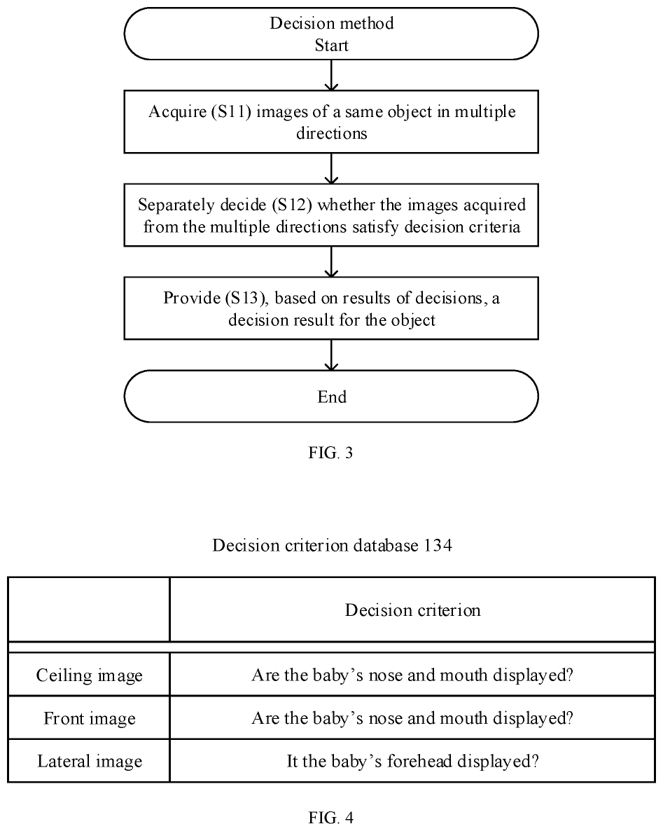

FIG. 3 is a flowchart of the decision method using the decision system 1. Processing performed by the above-mentioned hardware and software modules will be described.

In step S11, images of a same object are acquired from multiple directions.

The control unit 11 in the computer device 10 of the decision system 1 executes the image acquisition module 111 to issue (step S11) an instruction for acquiring the images of the same object to the capture unit 20 (the ceiling capture unit 21, the front capture unit 22, and the lateral capture unit 23) connected to the communication unit 12 via the network.

An image captured by the ceiling capture unit 21 is stored in the ceiling image data storage area 131 of the storage unit 13. An image captured by the front capture unit 22 is stored in the front image data storage area 132 of the storage unit 13. An image captured by the lateral capture unit 23 is stored in the lateral image data storage area 133 of the storage unit 13.

In step S12, it is separately determined whether the images acquired from the multiple directions satisfy decision criteria.

The control unit 11 then executes the decision module 112 to analyze (step S12) the images from the multiple directions which are acquired in processing in step S11 and stored in specified areas of the storage unit 13, and decide whether the decision criteria are satisfied, where the decision criteria are separately determined for the directions in which the images are acquired.

FIG. 4 shows an example of the decision criterion database 134 which is referred to in processing in step S12. In the decision criterion database 134, the decision criteria are separately determined for a ceiling image, a front image, and a lateral image.

The control unit 11 firstly analyzes the ceiling image stored in the ceiling image data storage area 131. Referring to the decision criterion database 134, it is determined whether a decision criterion “Are the baby's nose and mouth displayed?”, which is determined for the ceiling image, is satisfied.

Similarly, the control unit 11 analyzes the front image stored in the front image data storage area 132. Referring to the decision criterion database 134, it is determined whether a decision criterion “Are the baby's nose and mouth displayed?”, which is determined for the front image, is satisfied.

Moreover, the control unit 11 analyzes the lateral image stored in the lateral image data storage area 133. Referring to the decision criterion database 134, it is determined whether a decision criterion “Is the baby's forehead displayed?”, which is determined for the lateral image, is satisfied.

In step S13, based on results of decisions, a decision result is provided for the object.

The control unit 11 executes the provision module 113 to provide (step S13) the decision result for the object based on processing results in step S12. Examples of a method for providing the decision result include displaying on the image display unit 14 in the computer device 10, displaying on the portable terminal 2 connected to the computer device 10 via the network, and the like.

For example, only when all of the individual decisions in step S12 have a result of “no”, a decision result that the baby is in a prone state is provided. So long as one of the individual decisions in step S12 has a result of “yes”, a decision result that the baby is not in the prone state may be provided.

In addition, a value obtained by dividing the number of images which are decided to satisfy the decision criteria by the number of acquired images may also be provided as a proportion of images which are decided to satisfy the decision criteria.

For example, when all of the individual decisions in step S12 have the result of “no”, the value obtained by dividing the number “3” of images which are decided to satisfy the decision criteria by the number “3” of acquired images is the proportion of the images which are decided to satisfy the decision criteria, which is “100%”.

In addition, when two of the individual decisions in step S12 have the result of “no” and one of the individual decisions has the result of “yes”, the value obtained by dividing the number “2” of images which are decided to satisfy the decision criteria by the number “3” of acquired images is the proportion of the images which are decided to satisfy the decision criteria, which is “67%”.

In addition, when one of the individual decisions in step S12 has the result of “no” and two of the individual decisions have the result of “yes”, the value obtained by dividing the number “1” of images which are decided to satisfy the decision criteria by the number “3” of acquired images is the proportion of the images which are decided to satisfy the decision criteria, which is “33%”.

The control unit 11 may also instruct the image display unit 14 or the like to display values of the proportion, such as “100%”, “67%”, and “33%”.

With the invention according to the present embodiment, the images are acquired in the multiple directions for the same object, it is separately decided whether the images acquired in the multiple directions separately satisfy the decision criteria, and the decision result is finally provided based on the results of the individual decisions. Previously, in the case where no other sensors are used other than the capture unit, a final decision result is derived using merely an image acquired in one direction. In the invention according to the present embodiment, so long as an image acquisition device (the capture unit 20) which is easier to purchase than the other sensors is configured to be able to acquire the images of the same object in the multiple directions, it is possible to derive the decision result with the higher accuracy for a specified decision item even without using the other sensors.

In addition, with the invention according to the present embodiment, the decision result provided for the object is provided along with the proportion of the images which are decided to satisfy the individual decision criteria. Therefore, the degree of trustworthiness of the decision result can be grasped. For example, to further increase the degree of trustworthiness, the following method may be added as an option: another decision system which has higher accuracy and is more expensive is used for screening.

The above-mentioned units and functions are implemented by reading and executing specified programs by a computer (including a CPU, an information processing device and various terminals). The programs are provided in the form of being recorded on a computer-readable recording medium such as a floppy disk, a compact disk (CD) (such as a compact disc read-only memory (CD-ROM)), and a digital versatile disc (DVD) (such as a digital versatile disc read-only memory (DVD-ROM) and a digital versatile disc random access memory (DVD-RAM)). In this case, the computer reads the programs from the recording medium and transfers the programs to an internal storage device or an external storage device for storage and execution. In addition, the programs may also be recorded in advance on a storage device (recording medium) such as a magnetic disk, an optical disk or a magneto-optical disk, and provided from the storage device for the computer via a communication line.

The embodiments of the present disclosure have been described above, but the present disclosure is not limited to the above-mentioned embodiments. In addition, the effects described in the embodiments of the present disclosure are merely illustrative of the most appropriate effects produced by the present disclosure, and the effects of the present disclosure are not limited to the effects described in the embodiments of the present disclosure.

### LIST OF REFERENCE NUMBERS

1: Decision system
10: Computer device
11: Control unit
111: Image acquisition module
112: Decision module
113: Provision module
12: Communication unit
13: Storage unit
131: Ceiling image data storage area
132: Front image data storage area
133: Lateral image data storage area
14: Image display unit
20: Capture unit
21: Ceiling capture unit
22: Front capture unit
23: Lateral capture unit
2: Portable terminal

1.-4. (canceled)

5. A decision system, comprising:
a processor; and
a memory for storing instructions executable by the processor,
wherein when executing the instructions, the processor is configured to:
acquire images of a same object from a plurality of directions;
analyze the images acquired from the directions, and decide whether decision criteria are satisfied, wherein the decision criteria are separately determined for the directions in which the images are acquired; and
provide, based on results of decisions, a decision result for the object.

6. The decision system of claim 5, wherein the processor is configured to provide a result of dividing a number of images which are decided to satisfy the decision criteria by a number of the acquired images as a proportion of images which are decided to satisfy the decision criteria.

7. A decision method, comprising:
acquiring images of a same object from a plurality of directions;
analyzing the images acquired from the directions, and deciding whether decision criteria are satisfied, wherein the decision criteria are separately determined for the directions in which the images are acquired; and
providing, based on results of decisions, a decision result for the object.

8. A program, which is configured to cause a decision system to execute following steps:
acquiring images of a same object from a plurality of directions;
analyzing the images acquired from the directions, and deciding whether decision criteria are satisfied, wherein the decision criteria are separately determined for the directions in which the images are acquired; and
providing, based on results of decisions, a decision result for the object.

9. The decision system of claim 5, wherein the object is a baby on a bed,
wherein the decision criteria are used for deciding whether the baby on the bed is in a prone state,
wherein the processor is configured to provide the decision result to a terminal of a guardian of the baby.

10. The decision system of claim 5, wherein the object is a pregnant woman or animal,
wherein the decision criteria are used for deciding a progress of pregnancy of the pregnant woman or animal.

11. The decision system of claim 5, wherein the object is a crop,
wherein the decision criteria are used for deciding a breeding state of the crop,
wherein the processor is configured to provide the decision result to a terminal of a manager.

12. The decision system of claim 5, wherein the object is a fish,
wherein the decision criteria are used for deciding a health state of the fish,
wherein the processor is configured to provide the decision result to a terminal of a manager.

13. The decision system of claim 5, wherein the decision criteria are used for deciding fault or damage of the object,
wherein the processor is configured to provide the decision result to a terminal of a manager.

14. The decision method according to claim 5, wherein the object is a baby on a bed,
wherein the decision criteria are used for deciding whether the baby on the bed is in a prone state,
wherein providing the decision result comprises: providing the decision result to a terminal of a guardian of the baby.

15. The decision method according to claim 7, wherein the object is a pregnant woman or animal,
wherein the decision criteria are used for deciding a progress of pregnancy of the pregnant woman or animal.

16. The decision method according to claim 7, wherein the object is a crop,
wherein the decision criteria are used for deciding a breeding state of the crop,
wherein providing the decision result comprises: providing the decision result to a terminal of a manager.

17. The decision method according to claim 7, wherein the object is a fish,
wherein the decision criteria are used for deciding a health state of the fish,
wherein providing the decision result comprises: providing the decision result to a terminal of a manager.

18. The decision method according to claim 7, wherein the decision criteria are used for deciding fault or damage of the object,
wherein providing the decision result comprises: providing the decision result to a terminal of a manager.

19. A non-transitory computer-readable storage medium, comprising at least one program which, when executed by a processor, implements the method according to claim 7.
